(19) United States
(12) Patent Application Publication
(10) Pub. No.: US 2018/0169796 A1
(43) Pub. Date: Jun. 21, 2018

(54) BRAZING PROCESSES AND BRAZED PRODUCTS

(71) Applicant: Morgan Advanced Ceramics, Inc., Hayward, CA (US)

(72) Inventors: Richard Angus Clark, Charlotte, NC (US); Toshimasa Oyama, Palo Alto, CA (US); David Earl Slutz, Bethlehem, PA (US); Jaspal Singh Kamboj, San Jose, CA (US); Edgar Giovanni Vanegas-Hurtado, San Jose, CA (US)

(73) Assignee: Morgan Advanced Ceramics, Inc., Hayward, CA (US)

(21) Appl. No.: 15/580,379

(22) PCT Filed: Jun. 6, 2016
(86) PCT No.: PCT/EP2016/062785

§ 371 Date: Dec. 7, 2017

Related U.S. Application Data
(60) Provisional application No. 62/172,320, filed on Jun. 8, 2015.

(51) Int. Cl. B23K 35/02; B23K 35/00; B23K 1/00; B23K 35/36

(52) U.S. Cl. CPC B23K 35/0222; B23K 35/36; B23K 1/0008; B23K 35/001

(57) ABSTRACT

A process for joining articles comprises the steps of: joining the articles together at a brazing temperature to form one or more brazed joints in a brazed assembly, wherein at least one of the one or more brazed joints comprises a filler at least in part capable of age hardening at a temperature below the brazing temperature; and heat treating the brazed assembly at a temperature and for a time sufficient to age harden the filler at least in part; wherein the articles comprise at least one diamond body, and the filler comprises an active brazing alloy for brazing to the at least one diamond body.

This invention relates to processes for joining articles by brazing and soldering, and to articles joined by said processes.

Brazing and soldering are processes in which a molten filler metal (frequently referred to as a filler) is used to wet facing surfaces of a joint, and is then solidified on cooling to form a joint between the facing surfaces. Reaction or alloying at the junction between the brazing material and the articles to be joined may occur to a limited extent. Conventionally, brazing takes place above 450° C. and soldering at or below that temperature.

According to “Principles of Brazing” by Jacobson and Humpston, (ASM International, ISBN 0-87170-812-4), brazing has been known since about 3200BCE for joining metals, and so for some materials it could be considered a mature technology. However the range of materials that can be successfully brazed has been extended over recent years as methods have been developed to deal with such widely different materials as ceramics, glasses and composite materials. For example “active brazes” incorporate in conventional brazing alloys a small amount of metals to improve wetting and spread on ceramic materials (for example, and without limitation, titanium, zirconium, hafnium, vanadium, niobium, tantalum, chromium, molybdenum, tungsten, or silicon).

For brazing to occur the brazing material normally has a liquidus temperature below the solidus temperature of the materials to be brazed, and the temperatures used for brazing must not detrimentally affect the materials to be joined. For example, work hardened or precipitation hardened alloys may be detrimentally affected at brazing temperatures since their strength depends upon retaining a particular microstructure.

Precipitation hardening is a process in which an appropriate heat treatment of a material induces the precipitation of a finely divided phase within the material resulting in an increase in strength. This increase in strength can be damaged by exposure to high temperatures. Other mechanisms can provide similar hardening effects, for example spinodal hardening alloys and order-hardening alloys do not actually produce a precipitated phase but behave in a similar manner-aging at a relatively low temperature to produce a hardened product, and capable of losing their hardened properties if heated too much.

Precipitation hardenable alloys include, without limitation:—
Gold rich Au—Ag—Cu alloys of appropriate composition
Most aluminium engineering alloys
Copper based alloys of appropriate composition (see http://www.totalmateria.com/Article71.htm for examples of both precipitation hardening and spinodal hardening copper based alloys)
Nickel-chromium superalloys

It is known to heat treat brazed articles to provide precipitation hardening in bodies that have been brazed.

Where articles to be joined are formed of materials having widely differing coefficients of thermal expansion (CTE) the mismatch in coefficients can lead to excessive strains in the joint, particularly where loading on the joint is predominantly or substantially shear loading.

After filing the priority application to this invention the applicants became aware of U.S. Pat. No. 5,400,946, which discloses a method of joining hard metallic substances (e.g. carbides and tungsten chromium alloys) to steel. In this method an interlayer of a precipitation hardenable alloy is sheathed by brazing alloy foils, and after brazing heat treated to harden the alloy. It is mentioned that the high ductility of the interlayer is preserved during the entire cooling-down phase, and that during the cooling down from brazing temperature, care should be taken that the cooling down does not take place so rapidly that precipitation occurs.

A CTE mismatch is a problem in the field of securing polycrystalline diamond to substrates, for example to cemented tungsten carbide substrates. Various methods have been used for such brazes, for example that set out in U.S. Pat. No. 4,850,523. The nature of this application and the problems that result is set out in U.S. Pat. No. 7,487,849 which may be used as a dictionary for terms used in this application where not already evident to the person skilled in the art, or having access to the “Principles of Brazing” book mentioned above. “Principles of Brazing” and U.S. Pat. No. 7,487,849 are incorporated into this application by reference to the extent permissible by national law.

As mentioned in U.S. Pat. No. 7,487,849, brazing thermally stable polycrystalline (TSP) diamond to cemented tungsten carbide is one desired application. TSP typically has a linear CTE of around 2×10⁻⁶ K⁻¹ and cemented tungsten carbide typically has higher linear CTE (for example a cobalt bonded tungsten carbide may have a linear CTE of around 6×10⁻⁶ K⁻¹). Providing a secure joint between materials having such extreme difference in CTE is a technical challenge.

The problem of CTE mismatch with diamond is conventionally dealt with by:—
providing one or more interlayers of coefficient of thermal expansion intermediate those of the materials to be joined; and/or
providing compliant interlayers that will yield when the joint is placed under stress and thereby reduce the stresses on the materials being joined.

The problems arising from such an approach include that provision of an interlayer tends to lead to a thicker joint than where no interlayer is provided, and frequently of a material having much lower strength than the articles being joined. Additionally a braze joint can represent a region of lower stiffness than the materials being joined, and this can result in vibration between joined parts in use. The thicker the joint, the more scope there is for such vibration. The closer the stiffness of the braze to that of the materials being joined, and the thinner the braze, the less the scope for such vibration.

U.S. Pat. No. 7,487,849 discloses drill bits which have polycrystalline diamond compact cutters mounted thereon by brazing to form a cutting element that includes a substrate, a TSP diamond layer, a metal interlayer between the substrate and the diamond layer, and a braze joint securing the diamond layer to the substrate, wherein the braze joint has a shear strength greater than about 60,000 psi (^{˜}414 MPa) and the interlayer has a thickness determined by a formula.

U.S. Pat. No. 7,487,849 acknowledges that it is known to use interlayers in which the thickness of the metal interlayer is typically about 50% of the entire joint thickness: for example, a 0.1 mm (0.004″) metal layer sandwiched between two 0.05 mm (0.002″) braze foils.

U.S. Pat. No. 7,487,849 uses substantially thicker interlayers, (for example the minimum disclosed in examples or 0.33 mm (0.013″)) and claims that this provides increased shear strength. The present disclosure does not require such thick interlayers (for example permitting interlayers of 0.25 mm, 0.2 mm, 0.15 mm, 0.1 mm or below), but does not preclude their use. As will be exemplified below, the present invention permits the achievement of high shear strengths with thin braze thickness by managing the mechanical properties of the brazed joint and by choice of brazing alloy.

The inventors have realised that the problem of reducing vibration stress in use of diamond-brazed articles can be reduced by providing a braze in which part at least comprises a material capable of age hardening at a temperature below the brazing temperature and above the application temperature, stresses can be accommodated while the material is in a more ductile, less hardened state, and that following age hardening the strength and stiffness of the braze may be increased to improve joint strength and stiffness. Further, by choice of brazing alloy the inventors have provided a strong bond to diamond, improving adherence.

Accordingly the present disclosure provides a process for joining articles comprising the steps of:—
joining the articles together at a brazing temperature to form one or more brazed joints in a brazed assembly, wherein at least one of the one or more brazed joints comprises a filler at least in part capable of age hardening at a temperature below the brazing temperature; and
heat treating the brazed assembly at a temperature and for a time selected to age harden the filler at least in part;
   wherein the articles comprise at least one diamond body, and the filler comprises an active brazing alloy for brazing to the at least one diamond body.

By “a filler at least in part capable of age hardening” is meant that at least part of the filler is capable of age hardening. By “a time selected to age harden the filler at least in part” is meant a time that results in some or complete age hardening of at least part of the filler. Age hardening to the maximum hardness is not a requirement of the present disclosure.

Diamond bodies may include, without limitation, bodies comprising at least 75% by weight diamond, and may include bodies comprising >80%, >85%, >90% or >95% by weight diamond.

Active brazes for brazing to diamond include, for example, brazes that comprise one or more carbide-forming elements in sufficient amount to form covalent bonds where in contact with the adjoining diamond body surface. Suitable elements include, without limitation, titanium and chromium.

Further features of the present disclosure are evident from the claims and the following illustrative but non-limitative description and the drawings in which:—

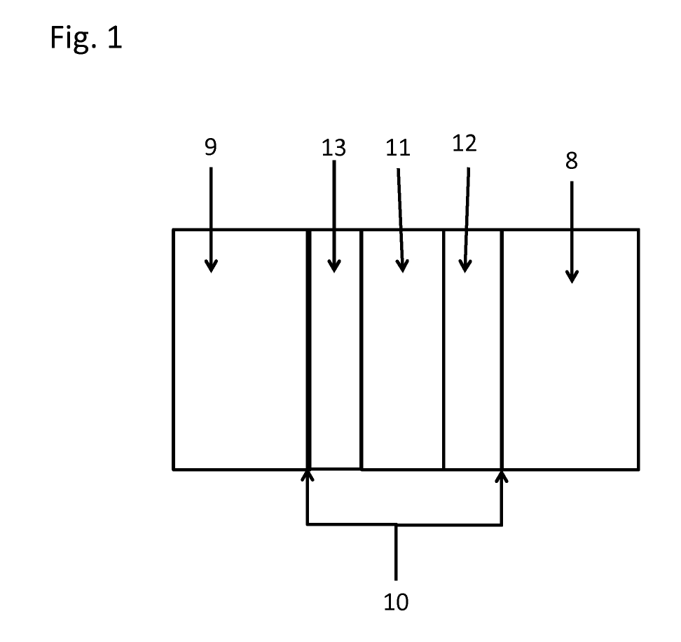

FIG. 1 is a schematic view of a braze joint construction

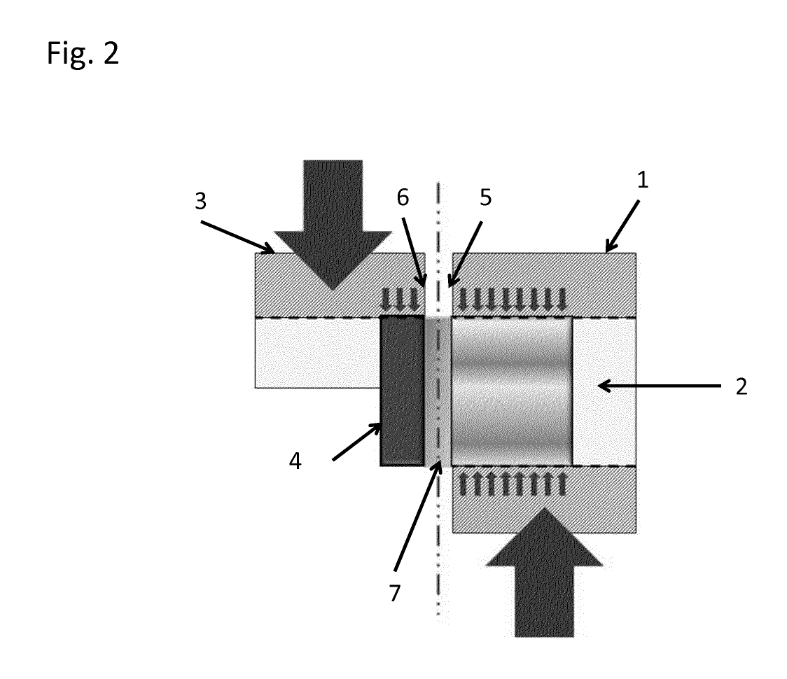

FIG. 2 is a schematic view of a shear testing arrangement

### EXAMPLES

The arrangement shown in FIG. 1 is of a first body 8 joined to a second body 9 by a braze joint 10 comprising an interlayer 11 and having a first brazing alloy foil 12 disposed between the first body 8 and interlayer 11; and a second brazing alloy foil 13 disposed between the second body 9 and interlayer 11. Such an arrangement is conventional and serves to show the present invention in one conventional context without being limited thereto.

### Example 1

To demonstrate the improvements achieved through the present disclosure, commercially available thermally stable polycrystalline (TSP) diamond layers of thickness 2.54 mm (0.1″) were brazed to commercially available cemented (cobalt bonded) tungsten carbide (WC) substrates of thickness 7.62 mm (0.3″) using a filler comprising a 0.1 mm (0.004″) thick foil of C18000 alloy (a heat treatable copper chromium silicon nickel alloy that has a melting point of approximately 1074° C. and precipitation hardens at temperatures in the range 425-540° C.) sandwiched between two 0.05 mm (0.002″) thick foils of Cusil-ABA® alloy (a silver-copper-titanium active brazing alloy of nominal composition Ag—63.0%, Cu—35.25%, Ti—1.75%).

A vacuum furnace was used with alternative heating regimes:—
a first that simply brazed the TSP to the WC to form a brazed assembly and then cooled down to room temperature;
a second that brazed the TSP to the WC and then held the brazed assembly at a heat treatment temperature for the C18000.

The firing regime used for simple brazing was
Ramp at 15° C./min to 685° C.
Hold at 685° C. for 20 min
Ramp at 5° C./min to 815° C.
Hold at 815° C. for 30 min
Furnace cool to room temperature.

The firing regime used for brazing and then heat treating was:—
Ramp at 15° C./min to 685° C.
Hold at 685° C. for 20 min
Ramp at 5° C./min to 815° C.
Hold at 815° C. for 30 min
Ramp at −5° C./min to 540° C.
Hold at 540° C. for 180 min
Ramp at −5° C./min to 425° C.
Hold at 425° C. for 180 min
Furnace cool to room temperature.

The shear strength of the resultant brazed joints were then tested by using an Instron Universal Testing machine model 5985 with a 250 kN load cell at a cross-head speed of 1.27 mm (0.05″) per minute. A shear rig was used as indicated in FIG. 2, in which a shear test fixture 1 received the WC substrate 2 and a shoe 3 was disposed against the brazed TSP 4 so that edges 5,6 of the fixture 1 and shoe 3 extend to the brazed joint. This arrangement placed the TSP 4 in compression with the force vector parallel to the braze joint transverse plane with a view to shear testing the joint rather than the adjacent materials. Four samples of each type of joint were tested

The shear strengths achieved are set out in Table 1 below:—

TABLE 1

| | |
|---|---|
| Sample | Joint shear strength [MPa] |

Example 1 - Heat treated samples

| | |
|---|---|
| Sample 1 | 412 |
| Sample 2 | 404 |
| Sample 3 | 423 |
| Sample 4 | 430 |
| Example 1 - Average value | 417 |

Comparative Example - Non-heat-treated samples

| | |
|---|---|
| Comparative Sample 1 | 265 |
| Comparative Sample 2 | 271 |
| Comparative Example - Average value | 268 |

### Example 2

A single sample was prepared using the same materials and firing regime as Example 1, except that a 0.05 mm (0.002″) thick foil of C18000 alloy was used. The joint shear strength measured was 350 MPa.

### Example 3

A single sample was prepared using the same materials and firing regime as Example 1, except that a 0.152 mm (0.006″) thick foil of C18000 alloy was used. The joint shear strength measured was 275 MPa.

Examples 1 to 3 illustrate that increasing thickness of the joint (as in U.S. Pat. No. 7,487,849) is not guaranteed to improve performance. However, Example 1 shows that for a brazed joint of given thickness and geometry, an improvement in shear strength is provided by the use of age hardening (in these examples precipitation hardening) fillers. The appropriate thickness for the brazed joint will depend upon materials, geometry, and desired application.

### Example 4

A single sample was prepared using the same materials regime as Example 1, except that the two 0.05 mm (0.002″) thick foils of Cusil-ABA® alloy were replaced by foils of the same thickness comprising Ticusil® alloy (a silver-copper-titanium active brazing alloy of nominal composition Ag—68.8%, Cu—26.7%, Ti—4.5%).

The firing regime was
Ramp at 15° C./min to 685° C.
Hold at 685° C. for 20 min
Ramp at 5° C./min to 845° C.
Hold at 845° C. for 30 min
Ramp at −5° C./min to 540° C.
Hold at 540° C. for 180 min
Ramp at −5° C./min to 425° C.
Hold at 425° C. for 180 min
Furnace cool to room temperature

The Joint shear strength measured was 379 MPa.

For comparison purposed it is noted that the shear strength of a brazed joint between the same materials, and using only a single 0.05 mm (0.002″) braze foil of Ticusil® alloy without the C18000 alloy, showed a shear strength of 250 MPa. Cusil-ABA® alloy gives similar shear strengths.

In each of examples 1 to 3 the firing regime is designed to diffuse a significant amount of the brazing alloy into the precipitation hardenable C18000 layer. This reduces the risk that the brazing alloy provides a region of low shear strength in comparison with the precipitation hardenable layer to provide an overall shear strength no better than if the entire joint were of brazing alloy.

### Variants

The present disclosure provides a process for joining articles comprising the steps of:
joining the articles together at a brazing temperature to form one or more brazed joints in a brazed assembly, wherein at least one of the one or more brazed joints comprises a filler at least in part capable of age hardening at a temperature below the brazing temperature, and
heat treating the brazed assembly at a temperature and for a time selected to age harden the filler at least in part.

By this process stresses can be accommodated while the material of the filler is in a more ductile, less hardened state, and following age hardening the strength of the braze will be increased to improve joint strength.

In the above examples a heat treatment includes ramping down from a brazing temperature to one or more hold temperatures, thereby permitting age hardening to occur during cooling, rather than as an additional post braze process. This process is preferred, as not requiring additional process steps, but is not compulsory. As an example of where a separate heat treatment step may be preferred, where there are multiple brazes involved, it may prove appropriate to form several brazes with ductile interlayers, and then age harden in a subsequent step.

The ductility of the material of the filler should be sufficient to allow for some stress relief before the filler is hardened, but the ductility required will depend not only on joint geometry but also on materials being brazed. For all age hardening materials the ductility before age hardening is higher than after hardening, and subject to having sufficient strength post age-hardening, the greater the difference in ductility between the material of the filler above the age hardening temperature and after hardening, the better the braze.

The above examples show a conventional interlayer geometry in which an interlayer (which typically does not completely melt at the brazing temperature) is sandwiched between two brazing alloys that will bond with both the interlayer and adjacent substrates so that the interlayer accommodates stresses caused by CTE mismatch. In the present disclosure the interlayer is chosen from materials hardened subsequent to the brazing step to strengthen the joint. Such a geometry is however only one way of achieving the beneficial effects of using a filler that is capable of age hardening at least in part.

It should be noted that:—
The brazing alloys of the above constructions may be of different composition so that the brazing alloy 12 on one side of the interlayer 11 is different to the brazing alloy 13 on the other side and matched to the materials of the respective adjacent first and second bodies 8,9. For example, a non-active braze may be provided between the braze material and the material to which the diamond is being brazed. This allows the mechanical and chemical behaviour of the brazing alloy foils to be optimised for the materials of the bodies being joined.
Where the material of the interlayer is capable of directly brazing to both of the substrates brazing alloy foils may be dispensed with. For example active alloy versions of precipitation hardenable alloys may be effective in some applications. In addition, pastes of brazing alloy powder and hardenable alloy powder may be of use in some applications.
Where the material of the interlayer is capable of directly brazing to only one of the substrates a suitable brazing alloy may be used to form the bond with the other substrate.
Alternative geometries may include, for example, a mesh of an age hardenable alloy with the brazing alloy penetrating the mesh and bonding to both substrates.

In short, in any known application, the use of a filler comprising in whole or in part an age hardenable material permits brazing stresses to be accommodated while the filler is relatively ductile, and the shear strength of the joint to be increased by suitable heat treatment after brazing.

As is well known, the filler used in a braze depends upon the characteristics of the materials to be used and so not all age hardenable alloys will be compatible with all materials to be brazed. Selection of a brazing alloy having appropriate brazing temperature and other characteristics to meet the characteristics of the materials being brazed will depend on application.

The active brazing alloys used in the examples comprise titanium to improve wetting and spread on the diamond, but the present invention is not limited to use of titanium containing active brazing alloys.

Although the above examples are related to brazing TSP to WC, the processes of the present disclosure are of broad applicability and may be used to bond diamond to similar or dissimilar materials including, without limitation the material combinations indicated with an X in Table 2:—

TABLE 2

| | | Oxide | Non-oxide | | | |
|---|---|---|---|---|---|---|
| | Metal | ceramic | ceramic | Graphite | Diamond* | Glass |
| Metal | ◯ | ◯ | ◯ | ◯ | X | ◯ |
| Oxide | ◯ | ◯ | ◯ | ◯ | X | ◯ |
| ceramic | | | | | | |
| Non-oxide | ◯ | ◯ | ◯ | ◯ | X | ◯ |
| ceramic | | | | | | |
| Graphite | ◯ | ◯ | ◯ | ◯ | X | ◯ |
| Diamond* | X | X | X | X | X | X |
| Glass | ◯ | ◯ | ◯ | ◯ | X | ◯ |

*including without limitation TSP, polycrystalline diamond (PCD), partially leached polycrystalline diamond, chemical vapour deposition diamond (CVD diamond), single crystal diamond and diamond composites

Joined articles may contain several brazed joints between different materials [e.g. Diamond brazed to carbide brazed to metal] and the invention includes without limitation any and all such combinations of materials.

For example, joints between materials other than diamond may be present as indicated with O in Table 2. An age hardenable interlayer may or may not be used for such joints between materials other than diamond, as the application demands. Brazed articles may comprise one or more joints as indicated as X in Table 2 either alone or with one or more joints as indicated as O in Table 2.

Age hardenable interlayers may provide particular advantage where at least two of the articles have linear coefficients of thermal expansion that differ by more than 50% or more than 100% of the linear coefficient of thermal expansion of the article having the lowest linear coefficient of thermal expansion at the brazing temperature

### INDUSTRIAL APPLICABILITY

There is a wide potential range of applications for this concept.

The examples show the brazing of WC to TSP. However the concept could be used for a wide variety of braze joints where adhesion and mismatch of CTE exists, for example:—
CVD diamond to carbide or to steel, etc.
   where the heat treatment temperature of the interlayer is appropriately chosen for the materials concerned.

Because the method of brazing and heat treating may be performed in a bulk furnace method (including without limitation, in a vacuum furnace or inert gas furnace)—it means it is possible:
a. To produce cutters for oil and gas drilling in bulk quantities as opposed to the industry-standard way of individually brazing them in induction units;
b. To directly join diamond (Polycrystalline Diamond/Thermally Stable Polycrystalline diamond) to drill bits instead of the standard method of:
   i. Joining diamond to carbide to form a cutter;
   ii. (Optional, but common) Joining carbide to carbide to extend the cutter length;
   iii. Brazing the cutter by a torch brazing or other method to drill bits

As an exemplary process for the present disclosure, a drill bit (standard is made using tungsten carbide powder within a molded “matrix” body or alternatively machined from steel) is included in a bulk (vacuum) furnace after diamond/TSP is positioned in appropriate jigs and the whole then taken through an appropriate heat cycle. Not only would this save significant cost, but potentially would make a better product since torch brazing processes are risky to the closely positioned diamond and the secondary braze of step ii is by necessity of much lower strength than the primary.

Another method would be similar to the method used to bond coated thermally stable diamonds to a bit body. In this case, the thermally stable diamond is placed in a mold with a braze alloy matrix on the TSP. Then the mold is filled with drill bit matrix powder (typically WC) and is put through a furnace cycle that not only sinters the drill bit matrix, but also brazes the joint and precipitation hardens the braze joint.

However, the present disclosure does not preclude joining by torch brazing, induction brazing, microwave brazing, resistance brazing, or any method appropriate to the application.

Typical applications in which the brazing method of the present disclosure may be used include:—
1. TSP bonded to carbide substrate for a drill bit cutter in any shape or geometry;
2. TSP/PCD/Diamond composite bonded to carbide or steel for mining picks (e.g. of the type disclosed in U.S. Pat. No. 5,092,310);
3. TSP/PCD/Diamond Composite bonded to carbide or steel for road (asphalt or other) picks;
4. TSP/PCD/Diamond Composite bonded to carbide or steel for picks for inclusion within hammer bits;
5. TSP/PCD/Diamond Composite bonded to carbide or steel for picks for inclusion in attritive (aggregate reduction) equipment;
6. CVD diamond/PCD bonded to carbide/steel for cutting tool blanks or directly for use as cutting tools;
7. CVD diamond bonded to copper/aluminium for heat sinks;
8. CVD diamond bonded to metals for surgical probes and other medical devices.

Various embodiments have been described above. It should be recognized that these embodiments are merely illustrative of the invention presently claimed. Numerous modifications and adaptations thereof will be readily apparent to those of skill in the art without departing from the scope of the invention claimed.

1. A process for joining articles comprising the steps of:
joining the articles together at a brazing temperature to form one or more brazed joints in a brazed assembly, wherein at least one of the one or more brazed joints comprises a filler at least in part capable of age hardening at a temperature below the brazing temperature; and
heat treating the brazed assembly at a temperature and for a time sufficient to age harden the filler at least in part;
wherein the articles comprise at least one diamond body, and the filler comprises an active brazing alloy for brazing to the at least one diamond body.

2. The process as claimed in claim 1 in which the filler comprises a portion that is solid at the brazing temperature, and a portion that is molten at the brazing temperature.

3. The process as claimed in claim 2 in which the portion that is solid at the brazing temperature is in the form of a foil.

4. The process as claimed in claim 3 in which the filler comprises a foil sandwiched between portions that are molten at the brazing temperature.

5. The process as claimed in claim 1, in which the filler comprises at least in part a precipitation hardenable alloy.

6. The process as claimed in claim 1 in which the filler comprises an interlayer capable of age hardening at a temperature below the brazing temperature sandwiched between brazing foils, at least one of which brazing foils comprises an active brazing alloy.

7. The process as claimed in claim 6, in which the interlayer has a thickness of less than 0.25 mm.

8. The process as claimed in claim 1 in which the articles comprise at least one ceramic body.

9. The process as claimed in claim 8 in which the at least one ceramic body includes at least one carbide body.

10. The process as claimed in claim 1 in which the steps of joining the articles together at a brazing temperature and heat treating the brazed assembly comprise the step of ramping down from a brazing temperature to one or more hold temperatures, thereby permitting age hardening to occur during cooling from the brazing temperature.

11. The process as claimed in claim 1 in which the articles comprise at least one diamond body brazed to at least one carbide body.

12. The process as claimed in claim 1, in which the diamond body is a thermally stable polycrystalline diamond body.

13. The process as claimed in claim 1 in which joining the articles together at a brazing temperature comprises vacuum brazing in a vacuum furnace.

14. The process as claimed in claim 13, in which the heat treated brazed assembly is or forms part of a cutting tool.

15. The process as claimed in claim 14, in which the heat treated brazed assembly is a drill bit.

16. A brazed article incorporating at least one brazed joint formed by the process of claim 1 comprising a diamond body brazed to a substrate.

17. The brazed article as claimed in claim 16, in which the article is or forms part of a cutting tool.

18. The brazed article as claimed in claim 16, in which the diamond body is a thermally stable polycrystalline diamond body.

19. The brazed article as claimed in claim 16, in which the substrate is a carbide body.

20. The brazed article as claimed in claim 16, in which the article is or comprises one of:
a drill bit
a drill bit cutter
a mining pick
a road pick
a pick for inclusion within hammer bits
a pick for inclusion in attritive (aggregate reduction) equipment
CVD diamond bonded to copper/aluminium for heat sinks; or
CVD diamond bonded to metals for surgical probes and other medical devices.
